(19) United States
(12) Patent Application Publication
(10) Pub. No.: US 2023/0297438 A1
(43) Pub. Date: Sep. 21, 2023

(54) AUTOMATED PATTERN GENERATION FOR ELASTICITY IN CLOUD-BASED APPLICATIONS

(71) Applicant: SAP SE, Waldorf (DE)

(72) Inventors: Rouven Krebs, Romerberg (DE); Maximilian Stefanac, Heidelberg (DE); Waldemar Firus, Wiehl (DE)

(21) Appl. No.: 17/699,296

(22) Filed: Mar. 21, 2022

(51) Int. Cl. G06F 9/50; G06F 11/34

(52) U.S. Cl. CPC G06F 9/5077; G06F 9/5022; G06F 11/3423; G06F 2209/5019

(57) ABSTRACT

Methods, systems, and computer-readable storage media for receiving a set of timeseries, each timeseries in the set of timeseries representing a parameter of execution of the system, pre-processing each timeseries in the set of timeseries to provide a set of pre-processed timeseries, merging timeseries in the set of timeseries to provide a merged timeseries, generating a consolidated timeseries based on the merged timeseries and a periodicity, deriving a pattern based on the consolidated time series, the pattern defining a scaling factor for each period in a timeframe, and executing, by an instance manager, scaling of the system based on the pattern to selectively scale one or more of instances of the system and controllable resources based on scaling factors of the pattern.

### BACKGROUND

Enterprises can use enterprise applications to support and execute operations. Enterprise applications can be deployed in on-premise environments, which includes execution of the enterprise applications on enterprise-dedicated hardware, such as a server system within a data center of an enterprise. Enterprise applications are increasingly deployed in cloud-computing environments, which includes execution of the enterprise applications within a data center of a cloud-computing provider (e.g., as part of an infrastructure-as-a-service (IaaS) offering). In some instances, an enterprise may consider migrating an enterprise application deployed within an on-premise environment to a cloud-computing environment. In such a scenario, the enterprise application executing in the on-premise environment can be referred to as a legacy application.

However, applying the operation models from an on-premise deployment of a legacy application to a deployment within a cloud-computing environment can come with significantly increased costs. For example, an operation model can require that the enterprise application is to be available 24 hours per day, 7 days per week. In such an operation model, the operation costs can be significantly higher when deployed within a cloud-computing environment than if deployed on-premise. To leverage cost savings potential, cloud-computing systems continuously adapt their subscribed resources to workload-dependent resource requirements. This can be referred to as elasticity. For example, in timeframes where an enterprise application is rarely used, instances of the enterprise application can be shut down to reduce burden on technical resources and/or free technical resources for other uses.

### SUMMARY

Implementations of the present disclosure are directed to elasticity in cloud-computing environments. More particularly, implementations of the present disclosure are directed to automatic determination of patterns for elasticity in cloud-computing environments.

In some implementations, actions include receiving a set of timeseries, each timeseries in the set of timeseries representing a parameter of execution of the system, pre-processing each timeseries in the set of timeseries to provide a set of pre-processed timeseries, merging timeseries in the set of timeseries to provide a merged timeseries, generating a consolidated timeseries based on the merged timeseries and a periodicity, deriving a pattern based on the consolidated time series, the pattern defining a scaling factor for each period in a timeframe, and executing, by an instance manager, scaling of the system based on the pattern to selectively scale one or more of instances of the system and controllable resources based on scaling factors of the pattern. Other implementations of this aspect include corresponding systems, apparatus, and computer programs, configured to perform the actions of the methods, encoded on computer storage devices.

These and other implementations can each optionally include one or more of the following features: pre-processing includes one or more of noise filtering, outlier handling, smoothing, creating data for missing values, adjusting time format, and adjusting resolution; parameters include one or more of load metrics, quality oriented metrics, resource utilization metrics, configuration metrics, and application-specific metrics, application-specific metrics comprising one or more of request rate, number of users, response time, CPU utilization, and configuration of thread pool sizes; merging time series includes aggregating values of each of the timeseries in the set of timeseries at respective timestamps; generating a consolidated timeseries includes aggregating values of the merged time series for each period in the timeframe; the pattern is included in a set of patterns, each pattern being associated with a rating that is based on one or more metrics representative of the pattern; and executing scaling includes one of starting and stopping execution of at least one instance to adjust a number of resources provisioned within at least one instance.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture for use of logic scaling sets in accordance with implementations of the present disclosure.

FIGS. 3A-3C depict example timeseries in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DETAILED DESCRIPTION

Implementations of the present disclosure are directed to elasticity in cloud-computing environments. More particularly, implementations of the present disclosure are directed to automatic determination of patterns for elasticity in cloud-computing environments. Implementations can include actions of receiving a set of timeseries, each timeseries in the set of timeseries representing a parameter of execution of the system, pre-processing each timeseries in the set of timeseries to provide a set of pre-processed timeseries, merging timeseries in the set of timeseries to provide a merged timeseries, generating a consolidated timeseries based on the merged timeseries and a periodicity, deriving a pattern based on the consolidated time series, the pattern defining a scaling factor for each period in a timeframe, and executing, by an instance manager, scaling of the system based on the pattern to selectively scale one or more of instances of the system and controllable resources based on scaling factors of the pattern.

Implementations of the present disclosure are described in further detail herein with reference to an example enterprise system provided as a landscape management system. An example landscape management system includes SAP Landscape Management (LaMa) and SAP Landscape Management Cloud (LaMa Cloud) provided by SAP SE of Walldorf, Germany. It is contemplated, however, that implementations of the present disclosure can be realized with any appropriate enterprise application.

To provide further context for implementations of the present disclosure, enterprises can use enterprise applications to support and execute operations. Enterprise applications can be deployed in on-premise environments, which includes execution of the enterprise applications on enterprise-dedicated hardware, such as a server system within a data center of an enterprise. More recently, enterprise applications are frequently deployed in cloud-computing environments, which includes execution of the enterprise applications within a data center of a cloud-computing provider (e.g., as part of an infrastructure-as-a-service (IaaS) offering). In some instances, an enterprise may consider migrating an enterprise application deployed within an on-premise environment to a cloud-computing environment. In such a scenario, the enterprise application executing in the on-premise environment can be referred to as a legacy application.

However, applying the operation models from an on-premise deployment to a deployment within a cloud-computing environment can come with significantly increased costs. For example, an operation model can require that an enterprise application is to be available 24 hours per day, 7 days per week. In such an operation model, the operation costs can be significantly higher when deployed within a cloud-computing environment than if deployed on-premise. To leverage cost savings potential, cloud-computing systems continuously adapt their subscribed resources to workload-dependent resource requirements. This can be referred to as elasticity. For example, in timeframes where an enterprise application is rarely used, instances of the enterprise application can be shut down to reduce burden on technical resources and/or free technical resources for other uses.

Scaling of systems is described in further detail in commonly U.S. application Ser. No. 16/912,870, filed on Jun. 26, 2020, and entitled Logic Scaling Sets for Cloud-like Elasticity of Legacy Enterprise Applications, the disclosure of which is expressly incorporated herein by reference for all purposes.

By way of non-limiting example, SAP LaMa, introduced above, supports enterprises in migrating on-premise deployments of enterprise applications to cloud-computing environments (e.g., IaaS offerings) in an effort to reduce resource consumption and associated costs borne by the enterprise. As part of this, services can be provided to scale instances of the enterprise application based on dynamic workloads. This scaling is typically achieved by starting instances (scale-out) and stopping instances (scale-in), such as application server instances. In a traditional approach, the enterprise can manually define patterns that scale an enterprise application based on a user-defined schedule. In general, a pattern can be described as a schedule of instances over a timeframe. For example, a user (e.g., an administrator employed by the enterprise) defines a certain scaling factor (e.g., percentage or number) of instances of the enterprise application for defined periods (e.g., hours) within a timeframe (e.g., day).

However, traditional approaches to defining patterns are manual, requiring user input, which includes several disadvantages. For example, the task of defining patterns requires knowledge of the dynamic resource demands of the system, knowledge of parameters that are relevant for a scaling decision and the degree to which individual parameters may be relevant, and knowledge on how to map individual resource demands to a respective number of needed instances/resources to meet the respective resource demand. Further, patterns must be designed to account for long-term capacity planning processes in information technology (IT) organizations. Manual patterns can be inefficient in terms of technical resources expended, if such a pattern were implemented. That is, for example, the pattern can scale-out instances, when such a scale-out is not actually required. On the other hand, manual patterns can scale-in instances, when such a scale-in results in insufficient resources, which can result in delays in processing requests.

In view of this, and as described in further detail herein, implementations of the present disclosure provide are directed to automatic determination of patterns for elasticity in cloud-computing environments. In some implementations, timeseries data representative of parameters of historical operation of a system are normalized and consolidated to provide a consolidated timeseries that is representative of a dynamic behavior of the system. One or more patterns are derived based on the consolidated timeseries, each pattern representing a number of instances that are to be executed for each period within a timeframe. In some examples, multiple patterns are provided, and each pattern is assigned a rating. A pattern can be selected for assignment to a system based on the rating. In some examples, a pattern can be appropriate for use in a particular timeframe (e.g., day, week, month), while another pattern may be appropriate for use in another timeframe (e.g., quarter end close, holiday season). For each timeframe, multiple patterns might be created with individual ratings specific to respective timeframes.

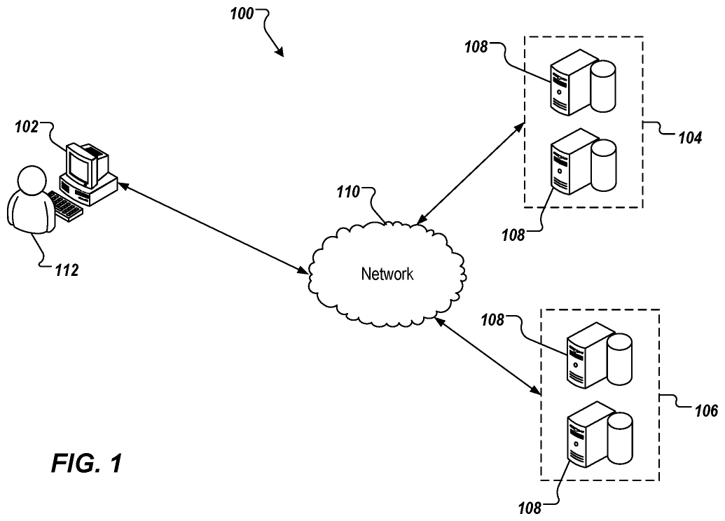

FIG. 1 depicts an example architecture 100 in accordance with implementations of the present disclosure. In the depicted example, the example architecture 100 includes a client device 102, a network 110, and server systems 104, 106. The server systems 104, 106 each include one or more server devices and databases 108 (e.g., processors, memory). In the depicted example, a user 112 interacts with the client device 102.

In some examples, the client device 102 can communicate with the server system 104 and/or the server system 106 over the network 110. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each of the server systems 104, 106 includes at least one server and at least one data store. In the example of FIG. 1, the server systems 104, 106 are intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host one or more managed systems (e.g., enterprise applications in a landscape) that support operations of one or more enterprises. Further, the server system 106 can host a landscape management system (e.g., SAP Landscape Management (LaMa) or SAP Landscape Management Cloud (LaMa Cloud)) that can be used to manage enterprise applications in a landscape. In some implementations, and as described in further detail herein, elasticity of instances of an enterprise application can be managed based on patterns, each pattern being a schedule of instances over a timeframe. For example, and as described in further detail herein, a pattern can define a number of instances of the application that are to be executed for each of multiple periods over the timeframe for a particular application.

In some implementations, as used herein, managed system or enterprise system can each refer to a set of software components and processes, which provide (together) a certain functionality. In some contexts, these components and processes are structured as instances (e.g., DB instance(s), application server instance(s), and central instance(s)/central service(s)). A system in the context of the present disclosure can include at least the DB instance and the central instances, which combines central services and one application server instance. Application servers provide the actual business logic, central services the shared technical functionality like enqueue services and the database storage. These instances can be installed together on one operating system/host or distributed on different individual hosts. In the context of the present disclosure, starting and stopping of instances/scaling of systems also implies the start/stop of the virtual machine (VM) the respective instance in running on. To leverage savings and to enable scaling, this can also imply installation of at least the application server instances on separate hosts/VMs.

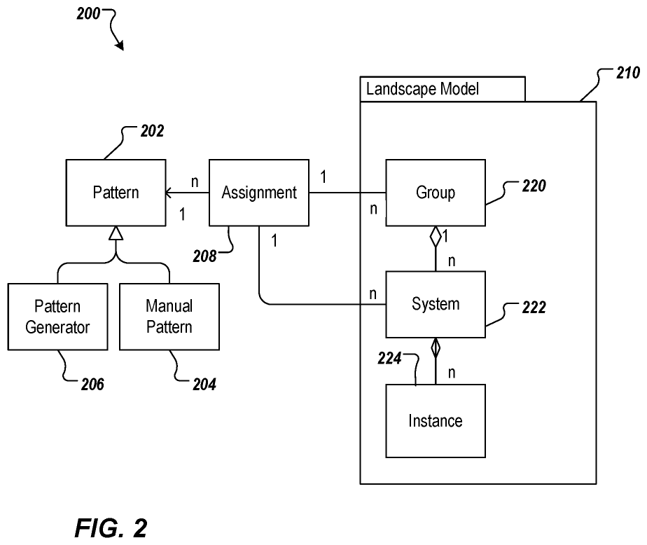

FIG. 2 depicts an example conceptual architecture 200 in accordance with implementations of the present disclosure. In the depicted example, the conceptual architecture 200 includes a pattern 202, a manual pattern 204, a pattern generator 206, an assignment 208, and a landscape model 210. The landscape model 210 includes a group 220, a system 222 (e.g., enterprise application executed within a landscape modeled by the landscape model 210), and an instance 224.

In some implementations, the assignment 208 associates the pattern 202 to either a group 220 or a system 222. For example, the assignment 208 can be provided as a data set that identifies a pattern 202 using a unique identifier that uniquely identifies the pattern 202 among a set of patterns, and that identifies one or more systems 222 and/or one or more groups 220 by respective unique identifiers that uniquely identify each system 222 or group 220.

Although a single group 220 is depicted in FIG. 2, one or more groups 220 can be defined within the landscape. Each group 220 is provided as computer-readable data that defines a set of systems (including one or more systems 222) that share some common properties (e.g., organization properties). For example, a group 222 can characterize workload behaviour that is the same for each system 222 in the set of systems. Accordingly, if the pattern 202 is associated with a group 220, the pattern 202 is applied to all of the systems 222 included in the group 220. Each group 220 can be of a different type of group. Example types of groups include, without limitation, a development group, a test group, a quality group, and a sandbox group. As noted above, each group 220 can include one or more systems 222.

Although a single system 222 is depicted in FIG. 2, one or more systems 222 can be executed within the landscape. In some examples, each system 222 provides one or more services to enterprises through execution of at least one enterprise application. Example services provided by a system can include, without limitation, enterprise resource planning (ERP) services, and customer relationship management (CRM) services. It is contemplated that implementations of the present disclosure can be realized with any appropriate enterprise application. As described herein, a system 222 can include one or more instances 224 of an enterprise application. More particularly, to be able to process potentially high workloads, a workload can be distributed across multiple instances 224.

In some implementations, the pattern 202 is provided as a computer-readable file that contains information on when a system (e.g., the system 222) or a group of systems (e.g., the group 220) is to be scaled within the landscape. The pattern 202 is provided as either the manual pattern 204 or an automatically generated pattern provided by the pattern generator 206. In some examples, the pattern 202 is provided as a computer-readable file that contains data defining a set of fixed periods within a timeframe and, for each period, an indication of a number of instances 224 of the system 222 that are to be running (e.g., scaled-out, scaled-in, stopped).

In accordance with implementations of the present disclosure, the pattern 202 is automatically generated by the pattern generator 206, which is provided as a computer-executable program. In some examples, the pattern generator 206 generates a set of recommended patterns that includes the pattern 202. The pattern 202 can be selected (e.g., by a user) from the set of recommended patterns.

In further detail, a set of timeseries that represents historical execution of workloads associated with an application is obtained. For example, an application can be executed by an enterprise for some period of time (e.g., months, years). During that period of time, data on parameters of the execution can be recorded. Example parameters can include, without limitation, a number of users (e.g., logged into the system), a utilization central processing units (CPUs), request rate, and software wait times (e.g., connection pooling). Although example parameters are discussed herein for purposes of illustration, it is contemplated that implementations of the present disclosure can be realized using any appropriate parameters. In some examples, the set of timeseries includes a timeseries for each parameter in the set of parameters. In some examples, the set of timeseries is specific to a particular enterprise and/or system, for which patterns are to be generated. In some examples, each timeseries is provided as a list of timestamps and, for each timestamp, a parameter value. In some examples, a resolution of the timestamps can differ as between timeseries (e.g., depending on parameter). For example, and without limitation, the number of users can be provided at X minute intervals, while the request rate is provided at Y second intervals. In some examples the timeseries may contain quality of service (QoS) related metrics (e.g., response times, throughput). Furthermore, configuration parameters (e.g., max work processes) or parameters providing insights into the actual application behaviour (e.g., number of executed batch processes) can be included.

In some implementations, timeseries in the set of timeseries are pre-processed for global alignment across all timeseries. In this manner, data across all parameters for arbitrary timestamps can be retrieved. In some examples, each timeseries is input to a pre-processor as a timeseries array, T [p] [e], where p is a parameter and e is an entry. Each entry includes a timestamp t and a parameter value v at that timestamp. In some implementations, pre-processing includes one or more of cleansing, editing, data wrangling, and data reduction. These can include, for example, noise filtering, outlier handling, smoothing, creating data for missing values, and the like.

In some examples, pre-processing of the timeseries results in synchronization of timing aspects and time formats that can be different across different data sources. For example, a first data source can provide timestamps in a first format (e.g., yy-MM-dd HH:mm:ss), while a second data source can provide timestamps in a second format (e.g., MMM dd, yyyy hh:mm:ss a). In pre-processing, the timestamps of the timeseries can be converted to a common format (i.e., common in that timestamps have the same format across all timeseries). As another example, a first data source can include an offset, while a second data source does not include an offset. In pre-processing, the offset can be removed from a timeseries provided from the first data source or can be added to a timeseries provided from the second data source.

In some examples, pre-processing includes adjusting a resolution of timeseries to provide the timeseries in a common resolution. In some examples, resolution indicates an interval (rate), at which values are recorded. For example, a first data source can record values of a first parameter at a first interval (e.g., every 10 seconds) and a second data source can record values of a second parameter at a second interval (e.g., every 1 minute). In some examples, pre-processing can adjust the resolution of one or more timeseries to the common resolution. In some examples, adjusting can include, among other possible techniques, interpolation and aggregation. For example, to adjust a resolution of a timeseries from a lower resolution (e.g., every 1 minute) to a higher resolution (e.g., every 10 seconds) new values can be generated by interpolating between the recorded values. As another example, to adjust a resolution of a timeseries from a higher resolution (e.g., every 10 seconds) to a lower resolution (e.g., every 1 minute) values can be filtered from the timeseries (e.g., delete values between 1 minute intervals). In some examples, adjusting the resolution of a timeseries from a higher resolution to a lower resolution can also include adjusting recorded values at the remaining intervals (e.g., based on an average of values that were removed between the intervals).

In some implementations, pre-processing includes normalizing values of each of the timeseries to be within a predefined range (e.g., [0, 1]). Normalizing of values can be executed using any appropriate normalizing technique and can be based on any appropriate metric. Example normalizing techniques can include, without limitation, linear scaling, clipping, log scaling, and Z score. Example metrics can include, without limitation, average/mean/median values of each timeseries, a defined quantile of all values for a timeseries, and minimum/maximum values.

In some implementations, pre-processing can include determining a trend for each timeseries and selectively removing one or more timeseries from consideration during pattern generation based on trend. For example, if a timeseries includes a linear trend, the timeseries can be removed. That is, a linear trend indicates absence of fluctuation of the parameter over time, such that the parameter would not be a good indicator of workload fluctuation for contribution to the pattern being generated. By removing a timeseries with a linear trend, less relevant data is removed from the pattern generation process, conserving resources expended in generating the pattern. In some examples, instead of removing the timeseries, the trend can be removed during normalization.

In some examples, so-called timeseries decomposition can be used, which splits the timeseries into a trend component, a seasonal component, and remainder component. Each component is itself a timeseries. Adding or multiplying (depending on the decomposition approach) all of the components together results in the original timeseries. The trend can be removed by performing decomposition and only adding/multiplying the seasonal component and the remainder component together.

In some implementations, the set of timeseries is processed to determine a periodicity. In general, periodicity represents a period within a timeframe, at which timeseries fluctuate. An example periodicity can include a period of 1 hour in a 24-hour timeframe. Another example periodicity can include a period of 1 week in a 52-week timeframe. In some examples, the set of timeseries is input to a periodicity engine that processes the timeseries using one or more techniques (e.g., Fourier analysis) to determine a periodicity for the set of timeseries. In some examples, a periodicity is provided for each timeseries in the set of timeseries (e.g., a first timeseries is assigned a first periodicity and a second timeseries is assigned a second periodicity that is different from the first periodicity). In some examples, periodicity is hard coded (e.g., week), is user-configured, or is derived by other sources (e.g., business data).

In accordance with implementations of the present disclosure, the timeseries in the set of timeseries are merged to provide a merged timeseries (i.e., a single timeseries). The pseudo-code of Listing 1, below, provides an example for merging the timeseries in the set of timeseries:

Listing 1: Example Pseudo-code to Merge Timeseries

```
define R[ ]; // relevance of a Timeseries, value between 0..1
define W[ ]; // normalized weight, value between 0..1
define Tm[ ];// merged times series
define i = lowest (Tp[ ].timestamp); //the first timestamp
  available
for each t in Tp[ ] {
  R[indexOf(t)] = calculateRelevance(t);
}
for each r in R[ ] {
  W[indexOf(r)] = calculateWeight(R, indexOf(r));
do {
  for each t in Tp[ ] {
    Tm[i] = Tm[i] + retrieveValue(t,i) * W[indexOf(t)]
  }
  i = increment(i);
} while at least one Tp[ ][i] is not empty;
```

In Listing 1, Tp [ ] is an array of timeseries (i.e., the timeseries in the set of timeseries) after pre-processing.

In merging the timeseries, functions are provided and include a weight calculation function (calculateWeight (R, int)), an increment function (increment (int)), a relevance calculation function (calculateRelevance (t [ ])), and a value retrieval function (retrieveValue (t [ ], timestamp)). In some examples, the weight calculation function calculates a weight as a value between 0 and 1 for the given timeseries, where the SUM for all timeseries weights is equal to 1 based on a relevance value (R). In this manner, the impact that individual timeseries have on the resulting, merged timeseries is adjusted. In some examples, the increment function increments the timestamp by a predefined step size (e.g., second, millisecond, minute). In some examples, the relevance calculation function provides the relevance value for the weight calculation. In some examples, the value retrieval function retrieves a value from the timeseries t for timestamp. The value can include a recorded value or an interpolated value (e.g., generated during pre-processing). In some examples, an additional function will normalize all values in T[p].value to make them comparable by, for example, normalizing to a value range of 0 to 1 by using the max and min values within the parameters respective time series (instead of min values we may also use 0 as a reference and normalize by the max values to 1 only). In some examples, the normalization might be implicitly done within the calculateWeight function. In this case, the sum of all weights might no longer be 1. In some examples, the normalization can be performed in previous steps (e.g., preprocessing).

In some implementations, the relevance and/or weight can be specific to a particular timeframe. In this manner, timeframes that are absent any data in some timeseries can be handled. For example, the relevance/weight can be set to 0 in this duration, which results in the data having no impact in generating the merged timeseries. In some examples, instead of calculating a weight and/or a relevance, an average/mean value can be used. In some examples, the weight and/or relevance can be predefined (e.g., hard-coded, user-selected). For example, a timeseries representing a number of requests can be predefined to be more relevant and should have a higher weight than a timeseries representing a number of users. In some examples, the weight and/or relevance can be automatically determined by comparing the timeseries in the set of timeseries. For example, a timeseries having a relatively high degree of variation can be considered more relevant and should have a higher weight than a timeseries having a relatively low degree of variation.

After merging, a singled, merged timeseries is provided, which abstracts the dynamic behavior of a set of parameters without a direct relation to a concrete parameter and/or absolute values. Further, the merged timeseries includes normalized values. The merged timeseries is referred to as Tm [ ] herein, where the dimension contains an entry Tm [ ].timestamp and Tm [ ]. value.

The merged timeseries is processed to provide condensed data. More particularly, the merged timeseries is processed to reduce data of the timeseries to a timeseries with a length of the periodic duration (i.e., timeframe) represented in the periodicity. The pseudo-code of Listing 2, below, provides an example for condensing data of the merged timeseries:

Listing 2: Example Pseudo-code to Condense Data

```
define C[ ][ ]; // resulting timeseries with condensed raw data
define stepWidth = 60; // defined stepwidth in the condensed
  data set.
define i = Tm[0].timestamp; //the first timestamp available
do {
  push(C[(i mod p)/stepWidth], = retrieveValue(Tm, i));
  i += stepWidth;
} while i < maxTimeStamp(Tm); //as long being in the
  timeseries
```

The function push appends the second parameter to the array of the first parameter. Thus, in this concrete example it adds values to the second dimension of C. The pseudo-code of Listing 2, results in a condensed timeseries C [ ] [ ], which includes values of the merged timeseries at timestamps determined from the periodicity. For example, if the periodicity (p) is 1-hour, values of the merged timeseries at each hour is selected for inclusion in the condensed timeseries.

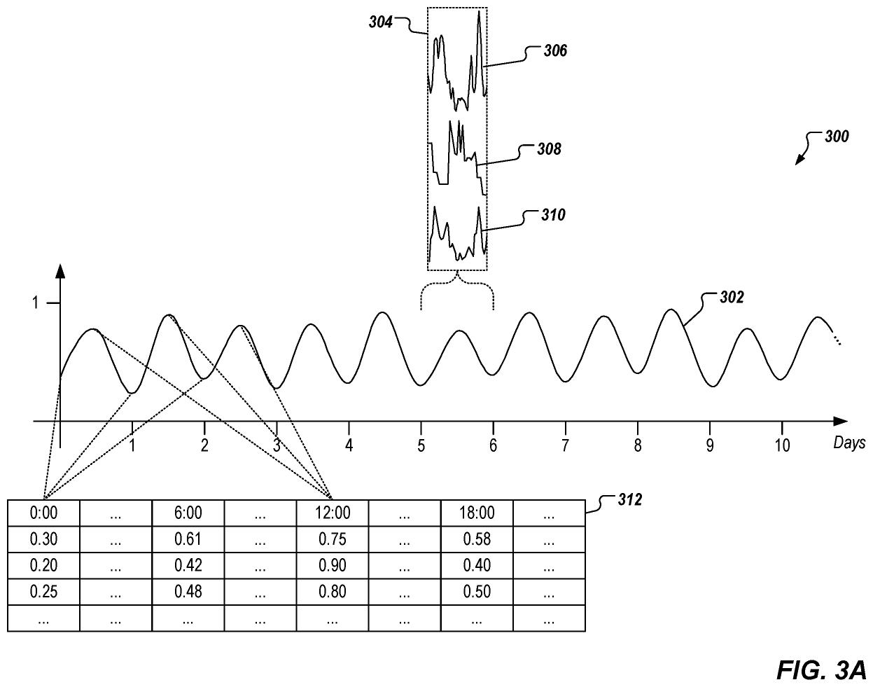

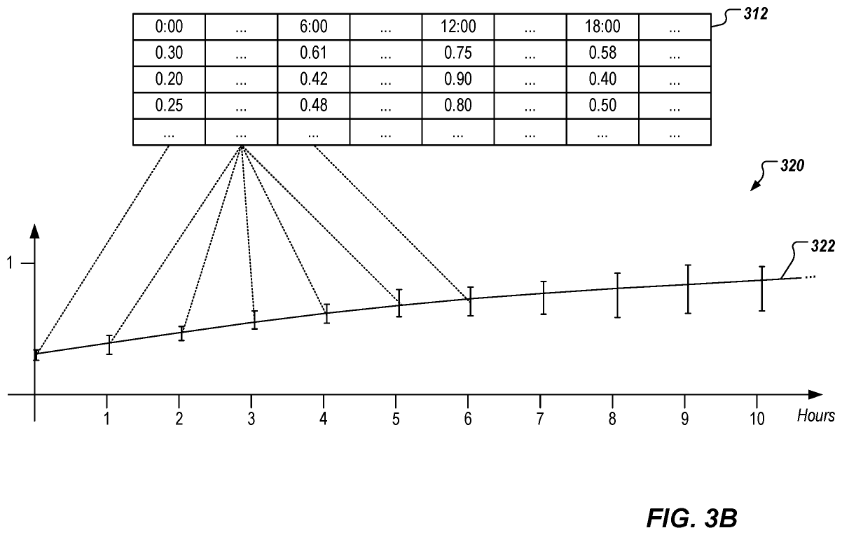

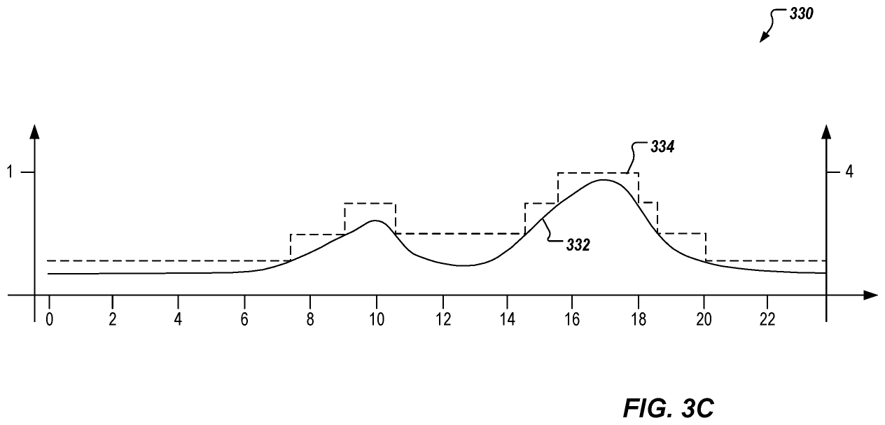

FIGS. 3A-3B depict example timeseries in accordance with implementations of the present disclosure.

With particular reference to FIG. 3A, a graph 300 graphically depicts an example merged timeseries 302, which abstractly represents the dynamic behavior of a set of parameters during execution of a system (e.g., the system 222 of FIG. 2). In the example of FIG. 3A, a set of timeseries 304 is depicted and includes a timeseries 306, a timeseries 308, and a timeseries 310, respectively depicted as snippets (e.g., over 1 day). For example, the timeseries 306 can represent number of CPUs, the timeseries 308 can represent request rate, and the timeseries 310 can represent number of users. The timeseries 306, 308, 310 are pre-processed and merged to provide the merged timeseries 302.

As also depicted in FIG. 3A, a table 312 is provided, which includes condensed data determined from the merged timeseries 302, as described herein. In the example of FIG. 3A, the table 312 represents a timeframe of 1 day, each column represents a period of 1 hour, and each row represents a respective day. Each cell is populated with a value representative of a value of the merged timeseries at a respective period (e.g., hour) on a respective day. In some examples, the value is determined as the value of the merged timeseries at the timestamp exactly on the period (e.g., value at 0:00, value at 1:00, value at 2:00, . . . ). In some examples, the value is determined as an aggregation of values of the merged timeseries over the respective period (e.g., average/minimum/maximum of values over the respective period).

In accordance with implementations of the present disclosure, a pattern is derived based on the consolidated data (e.g., the aggregated timeseries). In some examples, derivation of the pattern is based on one or more configurations. An example configuration can include a maximum number of instances that are available for scaling. The configuration can be predefined (e.g., hard-coded) or can be user selected. For example, the number of instances configured for derivation of the pattern can be different from the overall number of instances that are available in a landscape (e.g., some instances are reserved for central usage, such as a database). Another example configuration can include a minimum duration for each scale-in/scale-out event. This can avoid undesired oscillations of starting/stopping instances.

In some implementations, deriving the pattern assumes that a first workload (0) corresponds to no instances being executed and that a second workload (1) corresponds with the maximum number of instances (e.g., to meet service level agreement (SLA) commitments). In some examples, a linear relation is defined between a number of instances needed and the consolidated data. In some examples, a function is provided that calculates a number of instances based on the consolidated data. In some examples, derivation of the pattern relies on statistics of the consolidated data (e.g., mean, median, 95% quantile).

With particular reference to FIG. 3B, a graph 320 graphically depicts a portion of a consolidated timeseries 322. In some examples, the consolidated timeseries 322 is generated using the condensed data. For example, for each period, values of the condensed data can be aggregated to provide an aggregate value for that period. In the example of FIG. 3B, values in each column can be aggregated (e.g., average, minimum, maximum) to provide an aggregate value for a period within the consolidated timeseries 322. In some examples, values between aggregate values can be interpolated (e.g., linear interpolation) to fill out the consolidated timeseries 322. Accordingly, the consolidated timeseries 322 represents periods (e.g., 1 hour) within a single timeframe (e.g., 1 day). The consolidated timeseries 322 of FIG. 3B represents a consolidated dataset with a 95% quantile and mean value.

The pseudo-code of Listing 3, below, provides an example for deriving a pattern:

Listing 3: Example Pseudo-code to Derive Pattern

```
define S[ ]; // number of instances per consolidated data point
define stepWidth = 60; // stepwidth based on consolidated
  data.
define i = 0;
define maxInstances = 4; //following the example above
do {
  consolidatedMean = calcMean(C[i]);
  numberInstances = roundup(consolidatedMean*maxInstances);
  S[i] = numberInstances;
  i+=1
} while i < C.size; //as long being in the timeseries
```

Here, the pattern S [ ] represents the number of instances that are to be executed at each period (e.g., hour) within the timeframe (e.g., day). The example of Listing 2 is based on an example step width of 60 minutes, corresponding to the example period of 1 hour) and the maximum number of instances configured to 4 instances. Because of the known step width, the actual timestamp can be recalculated by multiplying with the index i with the step width. Also, minimum durations of stable configuration/scaling (e.g., to avoid oscillations) can be achieved by comparing durations of each configuration (each change in number of instances) to a threshold duration and removing configurations having a duration that is below the threshold duration (e.g., by setting the configuration to the next higher number of instances. For example, a number of instances is at 3, reduces to 2, then moves back up to 3. If the configuration of 2 instances is for a duration that is less than the threshold duration, the configuration of 2 instances is removed, and the number of instances remains at 3 over the duration.

With particular reference to FIG. 3C, a graph 330 depicts an example consolidated timeseries 332 and an example pattern 334. In the example of FIG. 3C, the pattern 334 includes fluctuations between 1 instance and 4 instances (e.g., the maximum number of instances is configured to 4).

In some implementations, multiple patterns can be generated to provide a set (array) of patterns s [ ] [ ], where the first dimension is a pattern and the second dimension is a scaling recommendations for a certain point in time. In some examples, patterns can be generated based on varying configurations and/or parameters in the pattern generation process. For example, multiple periodicities can be provided and a pattern can be generated based on each periodicity. As another example, different aggregation techniques can be used and a pattern can be generated based on each aggregation technique. In some examples, a hardcoded buffer is provided, which represents different patterns.

In some implementations, each pattern can be associated with a rating to enable a user to select a pattern from the set of patterns. In some examples, a rating can be determined based on one or more metrics. For example, each metric can be assigned a score that is representative of the metric relative to the pattern. The scores can be combined to provide a rating for the pattern. In some examples, the scores can be combined using any appropriate aggregation technique (e.g., average, weighted average, minimum, maximum).

An example metric can include an overall number of instances over the pattern (e.g., calculated as the integral of the scaling function). Another example metric is the amount of time (e.g., based on the consolidated data or the merged normalized) the scaling function would not provide the number of instances needed (e.g., after considering a SLA violation margin would result in violation time). Another example metric is the amount of time (e.g., based on the consolidated data or the merged normalized) the scaling function would provide too many instances. Another example metric is an integral between the merged normalized actual resource/instance demand and that provided in the pattern. Another example metric is the number of scaling events (e.g., number of times instances are scaled in/out). Another example metric includes resource efficiency achieved compared to running all instances 24/7. Another example metric includes a probability of load peaks (anomalies) for each period. This can be aggregated for all steps of the pattern to generate a score that considers load peaks, which do not occur in the defined periodicity of the pattern.

In some implementations, a pattern is selected for used in the landscape. For example, a user can select the pattern and can assign the pattern to a system. In some examples, instances of the system are automatically scaled in/out based on the pattern. In some examples, a pattern that is automatically generated can be manually adjusted. For example, the user can adjust the pattern before deploying the pattern for use in the landscape.

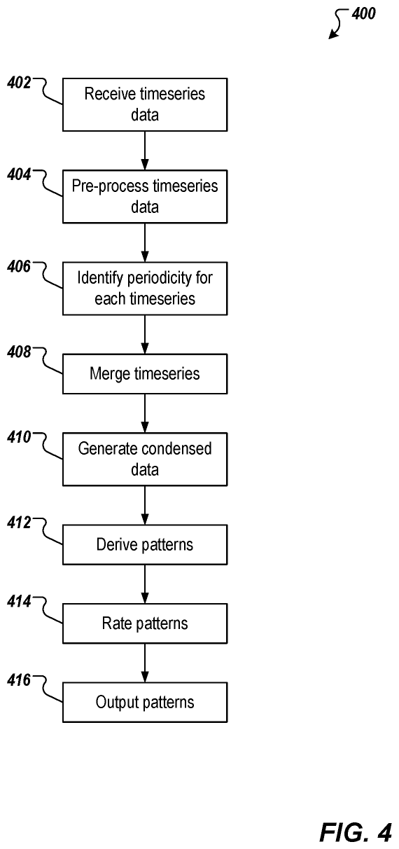

FIG. 4 depicts an example process 400 that can be executed in accordance with implementations of the present disclosure. In some examples, the example process 400 is provided using one or more computer-executable programs executed by one or more computing devices.

Timeseries data is received (402). For example, and as described herein, a set of timeseries that represents historical (actual) execution of workloads associated with an application is obtained. For example, an application can be executed by an enterprise for some period of time (e.g., months, years). During that period of time, data on parameters of the execution can be recorded. Example parameters can include, without limitation, a number of users (e.g., logged into the system), a utilization central processing units (CPUs), request rate, and software wait times (e.g., connection pooling). In some examples, a set of timeseries can represent synthetic execution of workloads associated with an application. That is, timeseries in the set of timeseries is artificially generated. The timeseries data is pre-processed (404). For example, and as described herein, pre-processing can include adjusting a resolution of timeseries to provide the timeseries in a common resolution, normalizing values of each of the timeseries to be within a predefined range, and/or determining a trend for each timeseries and selectively removing one or more timeseries from consideration during pattern generation based on trend.

A periodicity is identified for each timeseries (406). For example, and as described herein, the set of timeseries can be input to a periodicity engine that processes the timeseries using one or more techniques (e.g., Fourier analysis) to determine a periodicity for the set of timeseries. In some examples, a periodicity is provided for each timeseries in the set of timeseries. The timeseries are merged (408). For example, and as described herein, the timeseries in the set of timeseries are merged to provide a merged timeseries (e.g., using the pseudo-code of Listing 1).

Condensed data is generated (410). For example, and as described herein, the merged timeseries is processed to reduce data of the timeseries to a timeseries with a length of the periodic duration (i.e., timeframe) represented in the periodicity. Patterns are derived (412). For example, and as described herein, a pattern is derived based on the consolidated data based on one or more configurations. The patterns are rated (414). For example, and as described herein, each pattern can be associated with a rating to enable a user to select a pattern from the set of patterns. In some examples, a rating can be determined based on one or more metrics. For example, each metric can be assigned a score that is representative of the metric relative to the pattern. The scores can be combined to provide a rating for the pattern. The patterns are output (416). For example, and as described herein, patterns can be displayed to a user. In some examples, a pattern is selected for used in the landscape. For example, a user can select the pattern and can assign the pattern to a system. In some examples, instances of the system are automatically scaled in/out based on the pattern. In some examples, a pattern that is automatically generated can be manually adjusted. For example, the user can adjust the pattern before deploying the pattern for use in the landscape.

Implementations of the present disclosure provide the following example advantages. Implementations of the present disclosure provide for automated generation of patterns that, although abstractly, accurately represent a dynamic behavior of systems. In this manner, patterns enable resource efficiencies to be obtained through accurately provisioning instances and avoiding resource-wasteful execution of instances when not needed. Further, the patterns of the present disclosure mitigate risk of unexpected or non-deterministic system scaling to provide predictive system behavior. This enables activities, such as compliance, scheduling maintenance windows, and alerting. Also, the patterns of the present disclosure eliminate traditional problems such as oscillation, overcompensation, slow convergence, and delayed reaction (e.g., scaling up too late).

Implementations of the present disclosure further provide data visualizations (e.g., as depicted in FIGS. 3A-3C) that provide confidence on why/how patterns are generated, points of possible adjustment of a pattern (e.g., based on confidence intervals at a certain point in time or visualized outliers), and an understanding of the actual system behaviour. Further, implementations of the present disclosure provide resource-efficient calculation as compared to an optimization on overall available datasets through aggregation and consolidation in O(n) time complexity before deriving a pattern in O(n) time complexity.

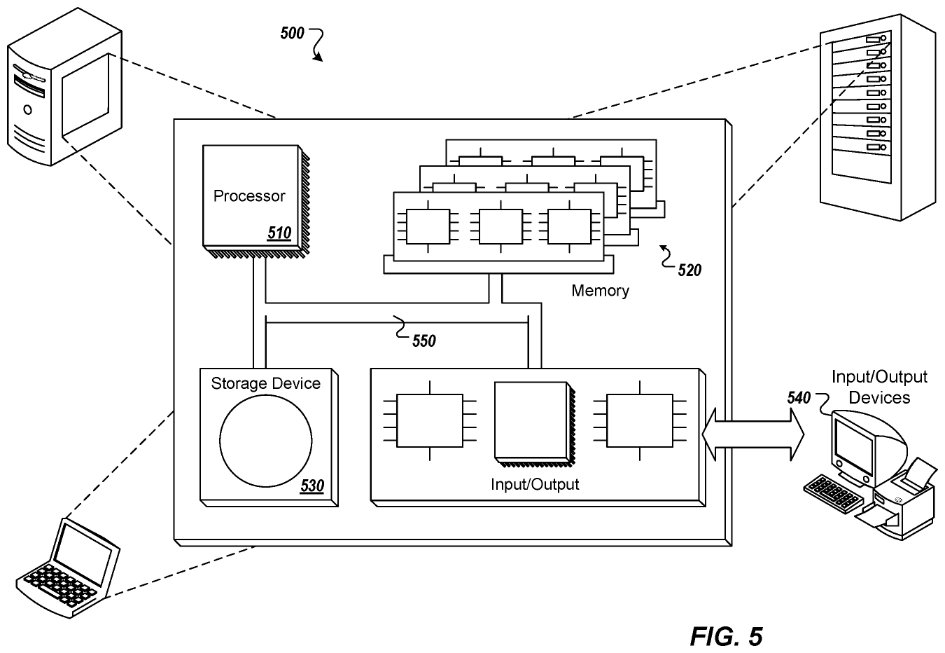

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for selective scaling of a system based on scaling one or more of instances executed within a landscape and controllable resources used for execution within the landscape, the method being executed by one or more processors and comprising:
receiving a set of timeseries, each timeseries in the set of timeseries representing a parameter of execution of the system;
pre-processing each timeseries in the set of timeseries to provide a set of pre-processed timeseries;
merging timeseries in the set of timeseries to provide a merged timeseries; generating a consolidated timeseries based on the merged timeseries and a periodicity;
deriving a pattern based on the consolidated time series, the pattern defining a scaling factor for each period in a timeframe; and
executing, by an instance manager, scaling of the system based on the pattern to selectively scale one or more of instances of the system and controllable resources based on scaling factors of the pattern.

2. The method of claim 1, wherein pre-processing comprises one or more of noise filtering, outlier handling, smoothing, creating data for missing values, adjusting time format, and adjusting resolution.

3. The method of claim 1, wherein parameters comprise one or more of load metrics, quality oriented metrics, resource utilization metrics, configuration metrics, and application-specific metrics, application-specific metrics comprising one or more of request rate, number of users, response time, CPU utilization, and configuration of thread pool sizes.

4. The method of claim 1, wherein merging time series comprises aggregating values of each of the timeseries in the set of timeseries at respective timestamps.

5. The method of claim 1, wherein generating a consolidated timeseries comprises aggregating values of the merged time series for each period in the timeframe.

6. The method of claim 1, wherein the pattern is included in a set of patterns, each pattern being associated with a rating that is based on one or more metrics representative of the pattern.

7. The method of claim 1, wherein executing scaling comprises one of starting and stopping execution of at least one instance to adjust a number of resources provisioned within at least one instance.

8. A non-transitory computer-readable storage medium coupled to one or more processors and having instructions stored thereon which, when executed by the one or more processors, cause the one or more processors to perform operations for selective scaling of instances of a system executed within a landscape, the operations comprising:
receiving a set of timeseries, each timeseries in the set of timeseries representing a parameter of execution of the system;
pre-processing each timeseries in the set of timeseries to provide a set of pre-processed timeseries;
merging timeseries in the set of timeseries to provide a merged timeseries; generating a consolidated timeseries based on the merged timeseries and a periodicity;
deriving a pattern based on the consolidated time series, the pattern defining a scaling factor for each period in a timeframe; and
executing, by an instance manager, scaling of the system based on the pattern to selectively scale one or more of instances of the system and controllable resources based on scaling factors of the pattern.

9. The non-transitory computer-readable storage medium of claim 8, wherein pre-processing comprises one or more of noise filtering, outlier handling, smoothing, creating data for missing values, adjusting time format, and adjusting resolution.

10. The non-transitory computer-readable storage medium of claim 8, wherein parameters comprise one or more of load metrics, quality oriented metrics, resource utilization metrics, configuration metrics, and application-specific metrics, application-specific metrics comprising one or more of request rate, number of users, response time, CPU utilization, and configuration of thread pool sizes.

11. The non-transitory computer-readable storage medium of claim 8, wherein merging time series comprises aggregating values of each of the timeseries in the set of timeseries at respective timestamps.

12. The non-transitory computer-readable storage medium of claim 8, wherein generating a consolidated timeseries comprises aggregating values of the merged time series for each period in the timeframe.

13. The non-transitory computer-readable storage medium of claim 8, wherein the pattern is included in a set of patterns, each pattern being associated with a rating that is based on one or more metrics representative of the pattern.

14. The non-transitory computer-readable storage medium of claim 8, wherein executing scaling comprises one of starting and stopping execution of at least one instance to adjust a number of resources provisioned within at least one instance.

15. A system, comprising:
a computing device; and
a computer-readable storage device coupled to the computing device and having instructions stored thereon which, when executed by the computing device, cause the computing device to perform operations for selective scaling of instances of a system executed within a landscape, the operations comprising:
receiving a set of timeseries, each timeseries in the set of timeseries representing a parameter of execution of the system;
pre-processing each timeseries in the set of timeseries to provide a set of pre-processed timeseries;
merging timeseries in the set of timeseries to provide a merged timeseries;
generating a consolidated timeseries based on the merged timeseries and a periodicity;
deriving a pattern based on the consolidated time series, the pattern defining a scaling factor for each period in a timeframe; and
executing, by an instance manager, scaling of the system based on the pattern to selectively scale one or more of instances of the system and controllable resources based on scaling factors of the pattern.

16. The system of claim 15, wherein pre-processing comprises one or more of noise filtering, outlier handling, smoothing, creating data for missing values, adjusting time format, and adjusting resolution.

17. The system of claim 15, wherein parameters comprise one or more of load metrics, quality oriented metrics, resource utilization metrics, configuration metrics, and application-specific metrics, application-specific metrics comprising one or more of request rate, number of users, response time, CPU utilization, and configuration of thread pool sizes.

18. The system of claim 15, wherein merging time series comprises aggregating values of each of the timeseries in the set of timeseries at respective timestamps.

19. The system of claim 15, wherein generating a consolidated timeseries comprises aggregating values of the merged time series for each period in the timeframe.

20. The system of claim 15, wherein the pattern is included in a set of patterns, each pattern being associated with a rating that is based on one or more metrics representative of the pattern.
